(19) United States
(12) Patent Application Publication
(10) Pub. No.: US 2025/0042184 A1
(43) Pub. Date: Feb. 6, 2025

(54) INK-JET RECORDING APPARATUS

(71) Applicant: CANON KABUSHIKI KAISHA, Tokyo (JP)

(72) Inventors: KAZUKI SONETA, Tokyo (JP); TAKEHIRO ITO, Tokyo (JP)

(21) Appl. No.: 18/784,734

(22) Filed: Jul. 25, 2024

(30) Foreign Application Priority Data
Aug. 3, 2023 (JP) 2023-127217

(51) Int. Cl. B41J 11/00

(52) U.S. Cl. CPC B41J 11/00244; B41J 11/007

(57) ABSTRACT

An ink-jet recording apparatus includes an ink image forming unit configured to form an ink image on a recording medium, and a fixing apparatus configured to fix the ink image while pinching and conveying the recording medium, wherein the fixing apparatus includes a first belt configured to rotate and come into contact with the ink image, a second belt configured to form a nip portion by coming into contact with the first belt, a first roller unit including rollers that come into contact with an inner circumferential surface of the first belt, a second roller unit including rollers that come into contact with an inner circumferential surface of the second belt, a first heater unit arranged on the inner circumferential surface of the first belt and configured to heat the nip portion contactlessly, and a second heater unit configured to heat the inner circumferential surface of the second belt contactlessly.

### BACKGROUND

### Field

The present disclosure relates to an ink-jet recording apparatus that forms an ink image on a recording medium.

### Description of the Related Art

If a user touches a recording medium that has just been recorded with an ink-jet recording apparatus and ink thereon has not yet dried, an image may be blurred, or the ink may adhere to his/her hands. In a case of an ink-jet recording apparatus of which a recording speed is high, a second recording medium may be stacked on a first recording medium before ink thereon dries, and a back side of the first recording medium may be smeared. Thus, ink-jet recording apparatuses, particularly high-speed recording models, require a means for drying and fixing ink on a recording medium.

In Ink-jet recording apparatuses, a heat fixing method is used for heating a recording medium immediately after recording as a means for drying and fixing ink. According to Japanese Patent Application Laid-Open No. 2010-201817, a configuration is discussed, in which a roller pair forms a nip portion to perform fixing.

In a case of the configuration in which a recording medium carrying an ink image passes through the nip portion formed between the roller pair to fix the ink image, a width of the recording medium in a conveyance direction is small. Thus, it is necessary to set a temperature of a fixing unit high. This may cause the ink image to evaporate, resulting in an image defect.

For this reason, a configuration in which belts form a nip portion is suggested.

### SUMMARY

According to some embodiments, an ink-jet recording apparatus includes an ink image forming unit configured to form an ink image on a recording medium, and a fixing apparatus that is arranged downstream of the ink image forming unit in a conveyance direction of the recording medium and is configured to fix the ink image on the recording medium while pinching and conveying the recording medium, wherein the fixing apparatus includes a first belt configured to rotate and come into contact with the ink image formed by the ink image forming unit, a second belt configured to form a nip portion by coming into contact with the first belt, a first roller unit including a plurality of rollers that comes into contact with an inner circumferential surface of the first belt and on which the first belt is suspended, a second roller unit including a plurality of rollers that comes into contact with an inner circumferential surface of the second belt and on which the second belt is suspended, a first heater unit that is arranged on the inner circumferential surface of the first belt and is configured to heat the nip portion contactlessly, and a second heater unit configured to heat the inner circumferential surface of the second belt contactlessly and to correspond to the second belt.

Further features of the present disclosure will become apparent from the following description of exemplary embodiments with reference to the attached drawings.

### BRIEF DESCRIPTION OF THE DRAWINGS

FIG. 1 is a schematic configuration diagram illustrating an image forming system according to an exemplary embodiment.

FIG. 2 is an overall configuration diagram illustrating a fixing system including a first belt unit and a second belt unit in an ink-jet recording apparatus according to a first exemplary embodiment.

FIG. 3 is a configuration diagram illustrating temperature sensors for controlling a temperature of the fixing system and for stopping a heater.

FIG. 4 is a hardware block diagram illustrating the first belt unit of the fixing system according to the first exemplary embodiment.

FIG. 5 is a flowchart of processing of the first belt unit of the fixing system according to the first exemplary embodiment.

FIG. 6 illustrates a configuration of a thermostat and a roller.

FIG. 7 is a configuration diagram illustrating temperature sensors for controlling a temperature of a lower fixing system and for stopping a heater.

FIG. 8 is a hardware block diagram illustrating the second belt unit of the fixing system according to the first exemplary embodiment.

FIG. 9 is a flowchart of processing of the second belt unit of the fixing system according to the first exemplary embodiment.

FIG. 10 illustrates a thermostat arranged outside a first belt.

FIG. 11 illustrates a thermostat arranged outside a second belt.

### DESCRIPTION OF THE EMBODIMENTS

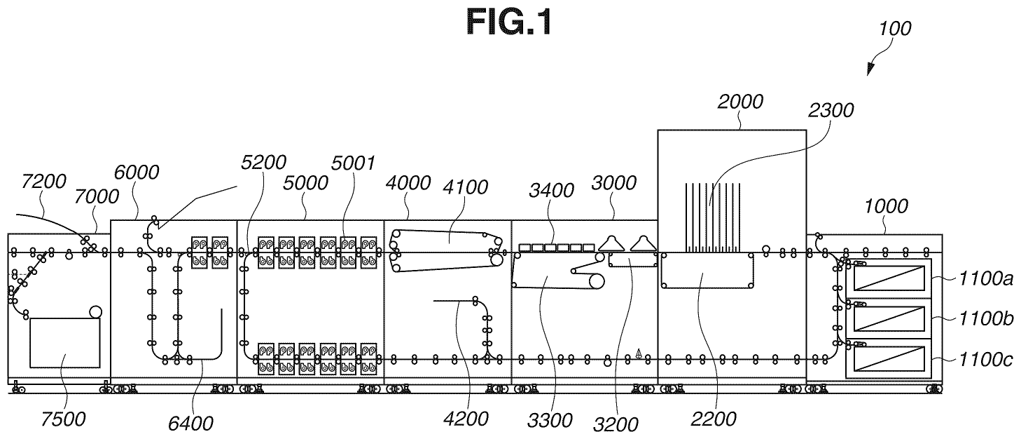

A first exemplary embodiment is to be described with reference to the attached drawings. First, a schematic configuration of an image forming system according to the present exemplary embodiment is to be described with reference to FIG. 1.

### Image Forming System

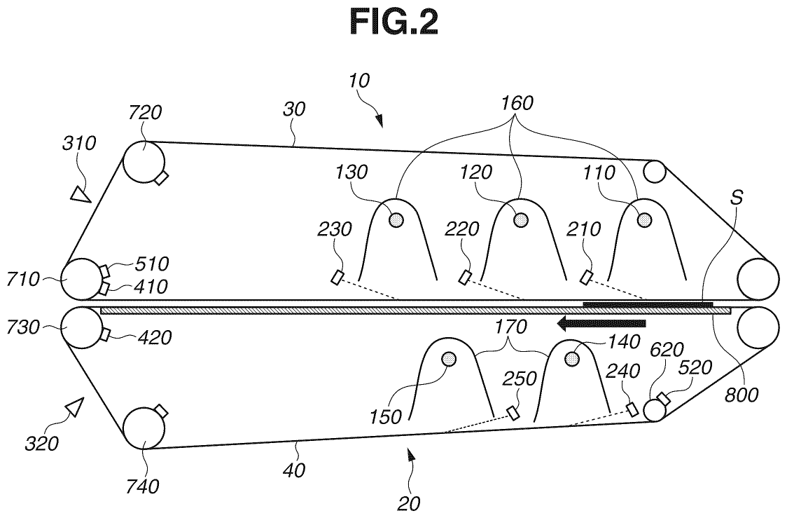

In an ink-jet recording apparatus 100 according to the present exemplary embodiment, an ink-jet recording method is used for ejecting ink to form an image on a recording medium. An ink image is formed on a recording medium with two liquids, a reaction solution and ink. A recording medium S, as shown in FIG. 2, may be any recording medium that can accept ink, such as plain paper, thick paper, a plastic film for an overhead projector, a special shape recording medium such as an envelope and index paper, and cloth.

As illustrated in FIG. 1, the ink-jet recording apparatus 100 according to the present exemplary embodiment is an example of an image forming apparatus and includes a feeding module 1000, an ink image forming unit 2000, and a drying module 3000. The ink-jet recording apparatus 100 further includes a fixing apparatus 4000, a cooling module 5000, a reversing module 6000, and a stacking module 7000. The recording medium S supplied from the feeding module 1000 is subjected to various types of processing while the recording medium S is conveyed along a conveyance path in each module and is finally discharged to the stacking module 7000.

The feeding module 1000, the ink image forming unit 2000, the drying module 3000, the fixing apparatus 4000, the cooling module 5000, the reversing module 6000 and the stacking module 7000 may each have separate housings, and these housings may be connected to form the ink-jet recording apparatus 100. Alternatively, the feeding module 1000, the ink image forming unit 2000, the drying module 3000, the fixing apparatus 4000, the cooling module 5000, the reversing module 6000 and the stacking module 7000 may be arranged in one housing.

The feeding module 1000 includes containers 1100a, 1100b, and 1100c that store the recording media S. The containers 1100a to 1100c can be pulled out toward a front side of the apparatus to store the recording media S. The recording media S are fed one by one by a separation belt and a conveyance roller from each of the containers 1100a to 1100c and conveyed to the ink image forming unit 2000. The configuration of the feeding module 1000 is not limited to a configuration including three containers 1100a to 1100c and may include one, two, or four or more containers.

The ink image forming unit 2000 includes a pre-image forming registration correction unit, a print belt unit 2200, and a recording unit 2300, and forms an ink image by ejecting ink to the recording medium S. Tilt and a position of the recording medium S conveyed from the feeding module 1000 are corrected by the pre-image forming registration correction unit, and the recording medium S is conveyed to the print belt unit 2200. The recording unit 2300 is arranged at a position facing the print belt unit 2200 across the conveyance path. The recording unit 2300 is an ink-jet recording unit that ejects ink from above onto the recording medium S being conveyed, using a recording head to form an ink image. A plurality of recording heads that ejects ink is arranged along a conveyance direction. According to the present exemplary embodiment, the recording unit 2300 includes a total of five line type recording heads corresponding to four colors of yellow (Y), magenta (M), cyan (C), and black (Bk) and to a reaction solution. The recording medium S is suctioned and conveyed by the print belt unit 2200, so that a clearance is secured with respect to the recording heads.

The number of ink colors and the number of recording heads are not limited to five as described above. The ink-jet recording method can include a method using a heating element, a method using a piezoelectric element, a method using an electrostatic element, and a method using a micro electro mechanical systems (MEMS) element. Ink of each color is supplied to the recording head from an ink tank (not illustrated) via an ink tube. The ink includes “0.1% to 20.0% by mass” of a resin component, water, a water-soluble organic solvent, a coloring material, a wax, and an additive based on the total mass of the ink.

The recording medium S on which an image is formed by the recording unit 2300 is detected by an inline scanner (not illustrated) arranged downstream of the recording unit 2300 in the conveyance direction of the recording medium S at the time of being conveyed by the print belt unit 2200. Here, deviation and color density of the image formed on the recording medium S are detected, and an image to be formed on the recording medium S and its density will be corrected based on the deviation and color density of the image.

The drying module 3000 is an example of a drying apparatus and blows hot air onto the recording medium S on which the image is formed by ejecting the ink to dry it. The drying module 3000 includes a decoupling unit 3200, a drying belt unit 3300, and a hot air blowing unit 3400. The drying module 3000 reduces liquid contents of the ink and reaction solution applied to the recording medium S in order to improve a fixing property of the ink to the recording medium S in the subsequent fixing apparatus 4000. The recording medium S on which the image is formed is conveyed to the decoupling unit 3200 arranged within the drying module 3000. The decoupling unit 3200 generates a frictional force between the recording medium S and a belt due to pressure of a wind blowing from above and causes the belt to convey the recording medium S. The recording medium S placed on the belt is conveyed by the frictional force, and thus the recording medium S is prevented from deviating during conveyance from the print belt unit 2200 to the decoupling unit 3200. The recording medium S conveyed from the decoupling unit 3200 is suctioned and conveyed by the drying belt unit 3300, and the hot air is blown from the hot air blowing unit 3400 located above the belt and dries the ink and reaction solution applied to the recording medium S.

The drying module 3000 heats the ink and reaction solution applied to the recording medium S to promote evaporation of moisture. Accordingly, it is possible to suppress an occurrence of cockling where an ink portion absorbs ink applied to the recording medium S and causes paper to stretch and wrinkle locally. As a heater for heating the air, for example, a heating wire or an infrared heater is desirable from the viewpoint of safety and energy efficiency. In addition to the method for applying hot air, the drying method may be configured by combining a method for irradiating a surface of the recording medium S with an electromagnetic wave (an ultraviolet ray, an infrared ray, and the like) and a conductive heat transfer method by contact with a heating element.

The fixing apparatus 4000 includes a fixing belt unit 4100. The fixing belt unit 4100 passes the recording medium S on which the image is formed and which is conveyed from the drying module 3000 through a nip portion formed between a heated first belt unit and a second belt unit.

Accordingly, the ink image is fixed to the recording medium S.

The cooling module 5000 includes a plurality of cooling units 5001, and the cooling units 5001 cool the high temperature recording medium S conveyed from the fixing apparatus 4000. The cooling unit 5001 draws outside air into a cooling box by using, for example, a fan to increase a pressure inside the cooling box and cools the recording medium S by blowing air to the recording medium S from the cooling box through a nozzle under pressure. The cooling units 5001 are disposed on both sides of the conveyance path of the recording medium S and cool both sides of the recording medium S.

The cooling module 5000 is provided with a conveyance path switching unit 5200. The conveyance path switching unit 5200 switches the conveyance path of the recording medium S depending on a case where the recording medium S is conveyed to the reversing module 6000 or a case where the recording medium S is conveyed to a double-sided conveyance path for double-sided printing in which images are formed on both sides of the recording medium S.

The reversing module 6000 includes a reversing unit 6400. The reversing unit 6400 reverses a front side and a back side of the recording medium S being conveyed and changes an orientation of the recording medium S between the front side and the back side in discharging the recording medium S to the stacking module 7000. The stacking module 7000 includes a top tray 7200 and a stacking unit 7500 and stacks the recording medium S conveyed from the reversing module 6000 thereon.

In double-sided printing, the recording medium S is conveyed to the conveyance path below the cooling module 5000 by the conveyance path switching unit 5002. Then, the recording medium S passes through the fixing apparatus 4000, the drying module 3000, the ink image forming unit 2000, and the double-sided conveyance path in the feeding module 1000 and is returned to the ink image forming unit 2000. A double-sided conveyance unit of the fixing apparatus 4000 is provided with a reversing unit 4200 that reverses the front side and the back side of the recording medium S. An image is formed with the ink on the other surface on which an image is not formed of the recording medium S returned to the ink image forming unit 2000, and the recording medium S is discharged from the drying module 3000 via the reversing module 6000 to the stacking module 7000.

### Fixing Apparatus

FIG. 2 is an overall configuration diagram illustrating the fixing apparatus 4000 including a first belt unit 10 and a second belt unit 20 in the ink-jet recording apparatus 100 according to the first exemplary embodiment. The ink-jet recording apparatus 100 performs printing on the recording medium S with the ink and fixes the ink by drying the moisture in the ink.

A rotatable first belt 30 included in the first belt unit 10 is heated by a heat source and comes into contact with the recording medium S to heat the recording medium S. A rotatable second belt 40 included in the second belt unit 20 forms a nip portion by coming into contact with the first belt 30. The first belt 30 and the second belt 40 sandwich and convey the recording medium S to fix the ink.

The first belt 30 and the second belt 40 are rotated by drive motors (not illustrated) serving as respective drive sources, and the recording medium S is conveyed in a direction of an arrow. The drive motor is connected to a first drive roller 720 and is driven to rotate, thereby causing the first belt 30 to rotate. The drive motor is connected to a second drive roller 740 and is driven to rotate, thereby causing the second belt 40 to rotate. The first drive roller 720 and the second drive roller 740 are rubber rollers with rubber surfaces. Using the rubber rollers can increase a grip force on the belt and convey the belt stably.

### First Belt Unit

The first belt unit 10 includes heaters 110, 120, and 130, a first roller unit including a plurality of rollers, temperature sensors 210, 220, and 230, and a temperature sensor 310 that controls a belt temperature.

The first belt 30 comes into contact with a front surface of the recording medium S on which the ink is applied by the ink image forming unit 2000. A first heater unit 160 that heats an inner circumferential surface of the first belt 30 contactlessly is arranged to heat the ink image on the recording medium S. The first heater unit 160 includes the heaters 110, 120, and 130, which are halogen heaters, and the heaters 110, 120, and 130 heat the inner circumferential surface of the first belt 30 contactlessly. The heaters 110, 120, and 130 are arranged side by side along the conveyance direction of the recording medium S. Further, the heaters 110, 120, and 130 heat the nip portion formed between the first belt 30 and the second belt 40. Thus, the heaters 110, 120, and 130 arranged on the inner circumferential surface of the first belt 30 are arranged side by side along the conveyance direction in the nip portion. The nip portion according to the present exemplary embodiment is configured to be wide enough in the conveyance direction so that the above-described arrangement is possible along the conveyance direction.

### Temperature Control and Safety Control of First Belt Unit

A rotation detection sensor 410 is a sensor that detects whether the belt is rotating and is arranged on a driven roller. A reason why the rotation detection sensor 410 is arranged on the driven roller is that in a case where the rotation detection sensor 410 is arranged on the drive roller, if the motor is driven even in a state where the first belt 30 is not attached, the drive roller will rotate and the rotation detection sensor 410 will falsely detect it, so that the rotation detection sensor 410 is arranged on the driven roller.

If the belt stops rotation, the rotation detection sensor 410 detects it and stops heating by the heaters 110, 120, and 130. The heaters 110, 120, and 130 are covered with reflectors and heat the belt directly below the heaters 110, 120, and 130. The temperature sensors 210, 220, and 230 are safety sensors that respectively detect temperatures of belt areas heated by the heaters 110, 120, and 130 and detect whether the temperature reaches 150° C. (Celsius) or higher. The temperature sensor 310 is a sensor that detects the belt temperature and controls the temperatures of the heaters 110, 120, and 130. The temperature of 150° C. is set to prevent the belt from deforming, and is not limited to this temperature because the temperature is determined depending on a material of the belt. The temperature sensor 310 that adjusts the belt temperature adjusts the temperature to be 100° C. downstream of the heaters 110, 120, and 130 to achieve high print quality. The temperature of 100° C. is the temperature for fixing the ink to the recording medium, and is not limited to this temperature because the temperature is determined depending on a material of the ink. However, if the temperatures of the heaters 110, 120, and 130 become higher than a predetermined temperature, it takes time to stop the heaters by the temperature sensor 310 that adjusts temperature. Thus, if the temperatures of the heaters 110, 120, and 130 become higher than the predetermined temperature, the temperature sensors 210, 220, and 230 can detect the temperatures directly below the heaters and stop driving of the heaters 110, 120, and 130. Two types of sensors are provided in this way, so that it is possible to precisely adjust the temperature of the paper to the predetermined temperature even if a long nip configuration is adopted.

Even if the temperatures of the heaters 110, 120, and 130 become higher than the predetermined temperature, the heaters 110, 120, and 130 can be stopped without deforming the belt. Considering a case where the temperature sensors 210, 220, and 230 fail and the temperature sensor 310 that controls the temperature of the belt also fails, a thermostat 510 is arranged on a first roller 710 downstream of the heaters 110, 120, and 130 in a rotation direction of the belt. If the belt temperature reaches a certain temperature or higher, the roller detected by the thermostat 510 is also heated, and if a roller temperature reaches a certain temperature or higher, the thermostat 510 disconnects alternating current (AC) lines of the heaters 110, 120, and 130.

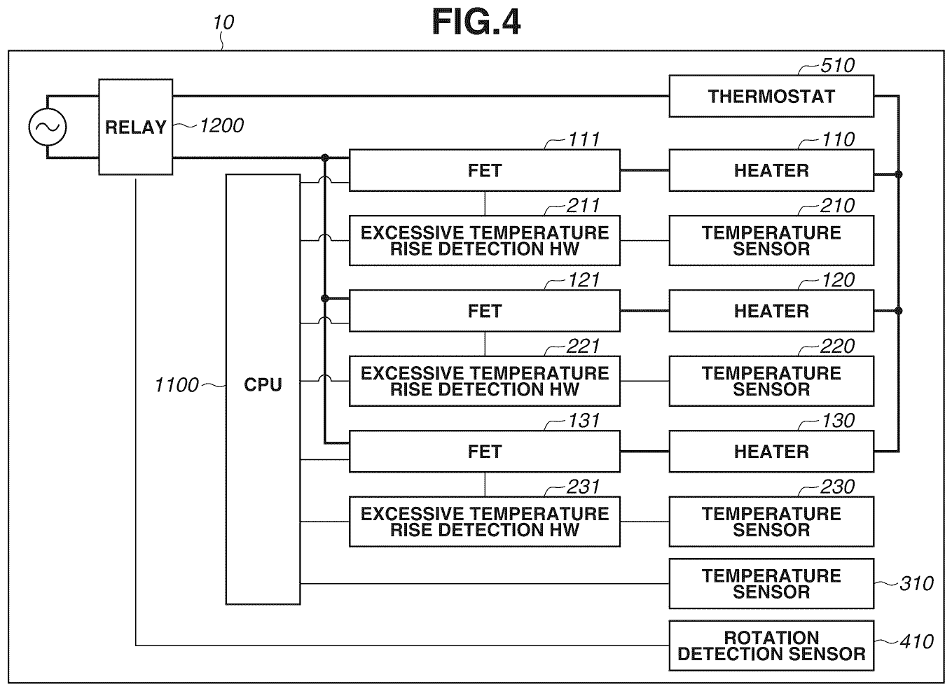

FIG. 4 is a hardware block diagram illustrating the first belt unit 10. The first belt unit 10 includes a central processing unit (CPU) 1100, a relay 1200, field effect transistors (FETs) 111, 121, and 131, excessive temperature rise detection hardware (HW) 211, 221, and 231, the heaters 110, 120, and 130, the temperature sensors 210, 220, and 230, and the temperature sensor 310.

The CPU 1100 controls the heaters 110, 120, and 130 by driving the FETs 111, 121, and 131 with ON/OFF control. The temperature sensors 210, 220, and 230 are respectively connected to the excessive temperature rise detection HW 211, 221, and 231 and detect that the temperature reaches 150° C. or higher using a hardware circuit. The temperature of 150° C. is set to prevent the belt from deforming, and is not limited to this temperature because the temperature is determined depending on the material of the belt. If any of the excessive temperature rise detection HW 211, 221, and 231 detects 150° C. or higher, the excessive temperature rise detection HW stops controlling the corresponding one of the FETs 111, 121, and 131. If the excessive temperature rise detection HW 211 detects the temperature of the temperature sensor 210, the excessive temperature rise detection HW 211 stops the control of the FET 111 but does not stop the control of the other FETs 121 and 131 by the hardware circuit. The CPU 1100 detects an interrupt signal from the excessive temperature rise detection HW 211 and stops the FETs 121 and 131 by software. According to the present exemplary embodiment, the FET is stopped by the CPU 1100, but it may be stopped by the hardware circuit. The thermostat 510 disconnects the AC line from the relay 1200 if the temperature reaches the predetermined temperature of higher.

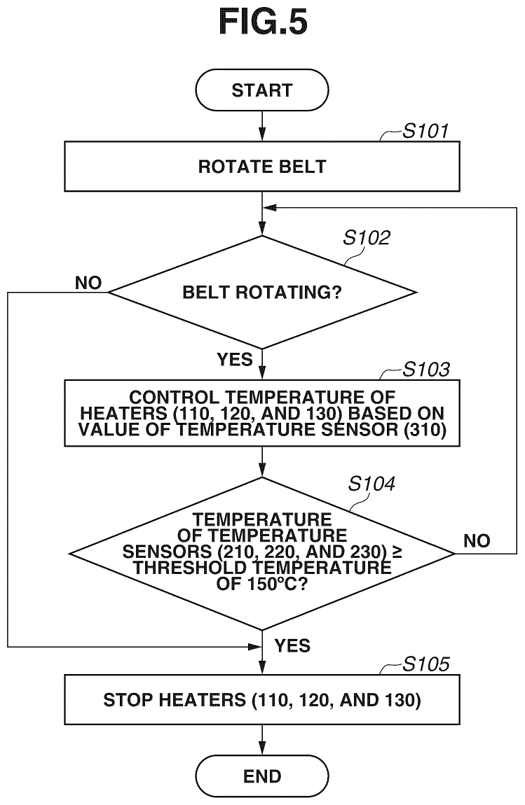

FIG. 5 is a flowchart of processing of the first belt unit 10. If fixing control is started, the processing proceeds to step S101.

In step S101, the CPU 1100 controls the drive motor of the first belt 30 to rotate the first belt 30. The CPU 1100 turns on the relay 1200.

In step S102, the CPU 1100 uses the rotation detection sensor 410 to determine whether the first belt 30 is rotating. In a case where the CPU 1100 determines that the first belt 30 is rotating (YES in step S102), the processing proceeds to step S103. In a case where the CPU 1100 determines that the first belt 30 is not rotating (NO in step S102), the processing proceeds to step S105.

In step S103, the CPU 1100 controls the temperatures of the heaters 110, 120, and 130 based on a temperature value read from the temperature sensor 310. The CPU 1100 controls the temperatures of the heaters 110, 120, and 130 by using a duty width of a pulse-width modulation (PWM) control signal with respect to the FETs 111, 121, and 131.

In step S104, in a case where the temperature value read by the CPU 1100 from the temperature sensors 210, 220, and 230 is a threshold temperature of 150° C. or higher (YES in step S104), the processing proceeds to step S105. In step S104, in a case where the temperature values read by the CPU 1100 from the temperature sensors 210, 220, and 230 are lower than the threshold temperature of 150° C. (NO in step S104), the processing proceeds to step S102.

In step S105, the CPU 1100 stops the heaters 110, 120, and 130.

Advantageously, the fixing apparatus 4000 includes the first belt unit 10 and the second belt unit 20 according to the present exemplary embodiment, where the first belt unit 10 includes the first rotatable belt 30, and the second belt unit 20 includes the second rotatable belt 40. As described above, the nip portion of the fixing apparatus 4000 according to the present exemplary embodiment is long in the conveyance direction of the recording medium S. Thus, the first belt 30 is in contact with the recording medium S for a long time. The first belt 30 is also in contact with the second belt 40 for a long time. Accordingly, the first belt 30 is heated by the first heater unit 160, but a large amount of heat may also be lost if the fixing apparatus 4000 did not include the second belt unit 20. This would make it difficult to maintain an appropriate temperature on an inside of the nip portion. Accordingly, there could be a possibility that the temperature of the recording medium S and the ink image on the recording medium S could not be raised to a desired temperature. Advantageously, according to the present exemplary embodiment, a configuration for heating the second belt 40 is provided in order to set the temperature appropriately at the nip portion. The specific configuration is to be described below.

### Second Belt Unit 20

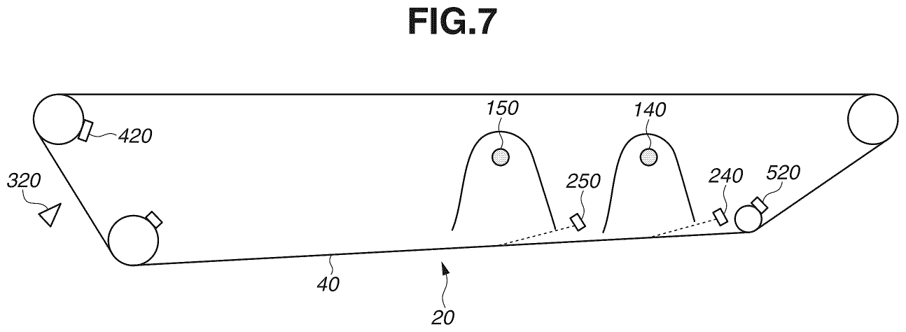

The second belt unit 20 is to be described with reference to FIGS. 2 and 7.

The second belt 40 includes heaters 140 and 150 to heat the recording medium S on which the ink is applied. The recording medium S is nipped long by both the first belt 30 and the second belt 40 and heated, so that the ink applied to the recording medium S penetrates therethrough, and high print quality is achieved.

The second belt unit 20 includes the heaters 140 and 150, a second roller unit including a plurality of rollers, temperature sensors 240 and 250, and a temperature sensor 320 that controls the belt temperature.

The second belt 40 comes into contact with a back surface of the recording medium S, which is an opposite surface to the front surface on which the ink is applied in the ink image forming unit 2000. In a case of double-sided printing, if the ink image forming unit 2000 forms an ink image on the back surface, the second belt 40 comes into contact with the front surface of the recording medium S.

The second belt unit 20 includes a second heater unit 170. The second heater unit 170 heats an inner circumferential surface of the second belt 40. A pad member 800 is arranged on the inner circumferential surface of the second belt 40. The pad member 800 functions as a backup member for the second belt 40 in order for the first belt 30 and the second belt 40 to form the nip portion. The pad member 800 is arranged, so that a width of the nip portion in the conveyance direction can be accurately determined, and further, the recording medium S can be stably conveyed.

Since the pad member 800 is arranged on the inner circumferential surface of the second belt 40, the second heater unit 170 heats the inner circumferential surface of the second belt 40 other than the nip portion. A configuration for heating the nip portion on the inner circumferential surface of the second belt 40 is a configuration in which the pad member 800 is directly heated and transfers the heat to the second belt 40. This configuration cannot efficiently heat the second belt 40, so that the second heater unit 170 heats the inner circumferential surface of the second belt 40 other than the nip portion.

However, in order to keep an appropriate temperature at the nip portion, the second heater unit 170 heats the portion other than the nip portion at a position close to the nip portion. Specifically, the second heater unit 170 is arranged in a half downstream area in the conveyance direction of a circumference of the second belt 40 other than the nip portion.

The second belt unit 20 includes the heaters 140 and 150. The heaters 140 and 150 are halogen heaters. According to the present exemplary embodiment, the number of halogen heaters included in the first heater unit 160 is greater than the number of heaters included in the second heater unit 170. This is because the first heater unit 160 needs to heat the ink applied onto the recording medium S by the ink image forming unit 2000. Thus, the first heater unit 160 requires more heat than the second heater unit 170.

A rotation detection sensor 420 is a sensor that detects whether the belt is rotating and is arranged on the driven roller. If rotation of the belt stops, the rotation detection sensor 420 detects it and stops heating by the heaters 140 and 150.

The heaters 140 and 150 are covered with reflectors and heat the belt directly below the heaters 140 and 150. The temperature sensors 240 and 250 are safety sensors that respectively detect temperatures of belt areas heated by the heaters 140 and 150 and detect whether the temperature reaches 150° C. or higher. The temperature of 150° C. is set to prevent the belt from deforming, and is not limited to this temperature because the temperature is determined depending on the material of the belt. The reflectors covering the heaters 140 and 150 are open toward a portion other than the nip portion. Accordingly, the heaters 140 and 150 can heat a position avoiding the pad member 800.

The reflectors arranged in the first belt unit 10 and the second belt unit 20 are open in the same direction. Arranging all reflectors in the same direction makes installation easier.

As described above, the heaters that heat the inner circumferential surface of the first belt 30 and the heaters that heat the inner circumferential surface of the second belt 40 are arranged, and thus the temperature within the nip portion can be appropriately maintained even in the present exemplary embodiment in which a long nip portion is formed. Accordingly, productivity can be improved.

### Temperature Control and Safety Control of Second Belt Unit

The temperature sensor 320 is a sensor that detects the belt temperature and controls temperatures of the heaters 140 and 150. The temperature sensor 320 that adjusts the belt temperature adjusts the temperature to be 100° C. downstream of the heaters 140 and 150 to achieve high print quality. The temperature of 100° C. is the temperature for fixing the ink to the recording medium, and is not limited to this temperature because the temperature is determined depending on the material of the ink. However, if the temperatures of the heaters 140 and 150 become higher than the predetermined temperature, it takes time to stop the heaters 140 and 150 by the temperature sensor 320 that adjusts the temperature. Thus, if the temperatures of the heaters 140 and 150 become higher than the predetermined temperature, the temperature sensors 240 and 250 can detect the temperatures directly below the heaters 140 and 150 and stop driving of the heaters 140 and 150. Two types of sensors are provided in this way, so that it is possible to precisely adjust the temperature of the recording medium S to the predetermined temperature even if the long nip configuration is adopted. Further, even if the temperatures of the heaters 140 and 150 become higher than the predetermined temperature, the heaters 140 and 150 can be stopped without deforming the belt.

Considering a case where the temperature sensors 240 and 250 fail and the temperature sensor 320 that controls the temperature of the belt also fails, a thermostat 520 is arranged downstream of the heaters 140 and 150 in the rotation direction of the belt. If the belt temperature reaches a certain temperature or higher, the roller on which the thermostat 520 is arranged is also heated. If a roller temperature reaches a certain temperature or higher, the thermostat 520 disconnects the AC lines of the heaters 140 and 150. In this way, even if the temperature sensors 240, 250, and 320 fail, the thermostat 520 safely disconnects the AC lines, and thus a safe fixing system can be realized.

FIG. 7 is a configuration diagram illustrating a temperature sensor.

The second belt unit 20 includes the heaters 140 and 150, the temperature sensors 240 and 250, and the temperature sensor 320 that controls the belt temperature. The heaters 140 and 150 are covered with the reflectors and heat the belt directly below the heaters 140 and 150. The temperature sensors 240 and 250 are the safety sensors that respectively detect the temperatures of the belt areas heated by the heaters 140 and 150 and detect whether the temperature reaches a certain threshold temperature or higher. The temperature sensor 320 is a sensor that detects the belt temperature and controls the temperatures of the heaters 140 and 150.

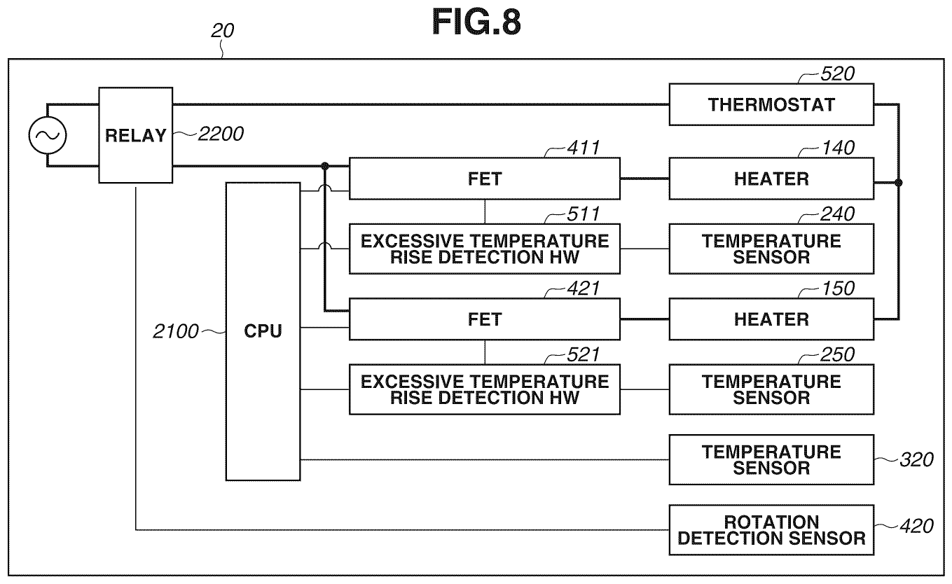

FIG. 8 is a hardware block diagram illustrating the second belt unit 20. The second belt unit 20 includes a CPU 2100, a relay 2200, FETs 411 and 421, excessive temperature rise detections HW 511 and 521, the heaters 140 and 150, the temperature sensors 240, 250, and 320. The CPU 2100 controls the heaters 140 and 150 by driving the FETs 411 and 421 with ON/OFF control. The temperature sensors 240 and 250 are respectively connected to the excessive temperature rise detections HW 511 and 521 and detect that temperature reaches 150° C. or higher using a hardware circuit. The temperature of 150° C. is set to prevent the belt from deforming, and is not limited to this temperature because the temperature is determined depending on the material of the belt. If any of the excessive temperature rise detections HW 511 and 521 detects 150° C. or higher, the excessive temperature rise detection HW stops controlling the corresponding one of the FETs 411 and 421. If the excessive temperature rise detection HW 511 detects the temperature of the temperature sensor 240, the excessive temperature rise detection HW 511 stops the control of the FET 411 but does not stop the control of the other FET 421 by the hardware circuit. The CPU 2100 detects an interrupt signal from the excessive temperature rise detection HW 511 and stops the FET 421 by software. According to the present exemplary embodiment, the FET is stopped by the CPU 2100, but it may be stopped by the hardware circuit. The thermostat 520 disconnects the AC line from the relay 2200 if the temperature reaches the predetermined temperature of higher.

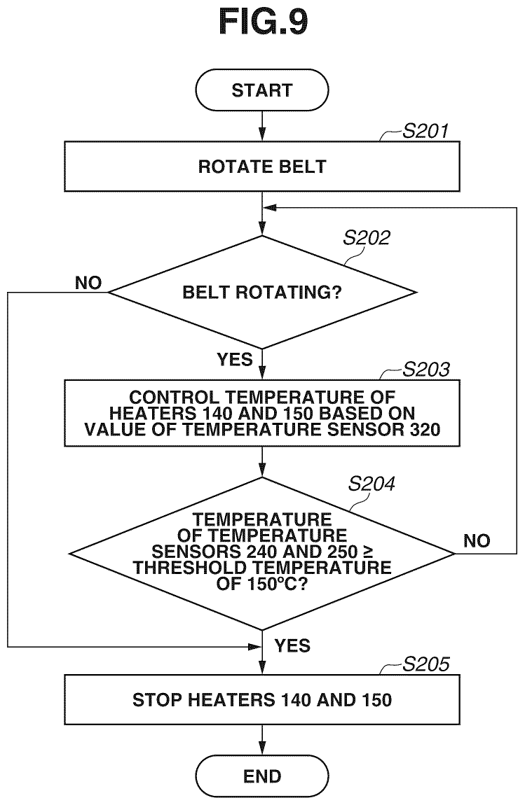

FIG. 9 is a flowchart of processing of the second belt unit 20. If the fixing control is started, the processing proceeds to step S201.

In step S201, the CPU 2100 controls the drive motor of the second belt 40 to rotate the second belt 40. The CPU 2100 turns on the relay 2200.

In step S202, the CPU 2100 uses the rotation detection sensor 420 to determine whether the second belt 40 is rotating. In a case where the CPU 2100 determines that the second belt 40 is rotating (YES in step S202), the processing proceeds to step S203. In a case where the CPU 2100 determines that the second belt 40 is not rotating (NO in step S202), the processing proceeds to step S205.

In step S203, the CPU 2100 controls the temperatures of the heaters 140 and 150 based on a temperature value read from the temperature sensor 320. The CPU 2100 controls the temperatures of the heaters 140 and 150 by using a duty width of a PWM control signal with respect to the FETs 411 and 421.

In step S204, in a case where the temperature value read by the CPU 2100 from the temperature sensors 240 and 250 is the threshold temperature of 150° C. or higher (YES in step S204), the processing proceeds to step S205. In step S204, in a case where the temperature values read by the CPU 2100 from the temperature sensors 240 and 250 are lower than the threshold temperature of 150° C. (NO in step S204), the processing proceeds to step S202.

In step S205, the CPU 2100 stops the heaters 140 and 150.

According to a second exemplary embodiment, a configuration is to be described in which a thermostat is provided to quickly detect a runaway of a heater in a case where the heater runs out of control.

A heat source that heats the belt is arranged in the fixing apparatus 4000. A thermostat is arranged in case the heat source, which is the heater, runs out of control. The thermostat is a non-contact temperature detection member and disconnects the AC line if a predetermined temperature is detected as described in the first exemplary embodiment.

In the fixing apparatus 4000 according to the present exemplary embodiment that forms a long nip in the conveyance direction, a distance is long between rollers on which the belt is suspend. Accordingly, the belt sags. If the thermostat attempts to detect the belt temperature in such a configuration, a distance between the belt and the thermostat may vary. There is a possibility that the thermostat cannot accurately detect the belt temperature due to the variation and a runaway of the heater cannot be detected quickly.

According to the second exemplary embodiment, the thermostat is arranged on the roller to solve the above-described issue. Details are to be described below.

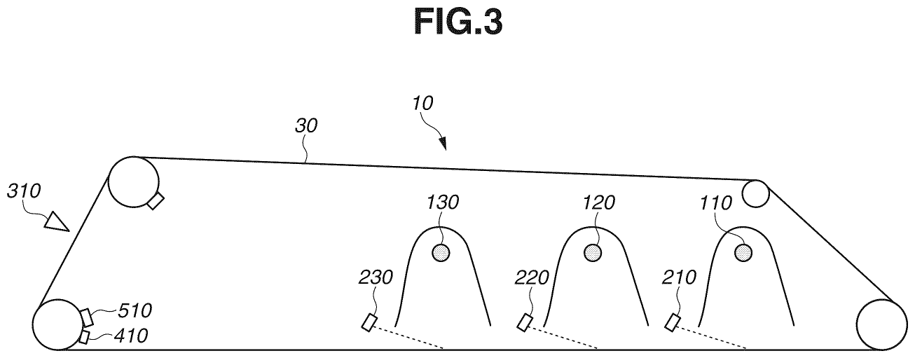

FIG. 3 is a configuration diagram illustrating the temperature sensors in the first belt unit 10.

The first belt unit 10 includes the heaters 110, 120, and 130, the temperature sensors 210, 220, and 230, and the temperature sensor 310 that controls the belt temperature. The heaters 110, 120, and 130 are covered with the reflectors and heat the belt directly below the heaters 110, 120, and 130. The temperature sensors 210, 220, and 230 are the safety sensors that respectively detect temperatures of belt areas heated by the heaters 110, 120, and 130 and detect whether the temperature reaches the certain threshold temperature or higher. The temperature sensor 310 is the sensor that detects the belt temperature and controls the temperatures of the heaters 110, 120, and 130.

The thermostat 510 (first temperature detection member) is arranged to detect a temperature of the roller on which the first belt 30 is suspended. The thermostat 510 detects a temperature of the first roller 710 illustrated in FIG. 2 contactlessly. The first roller 710 is arranged downstream of the heaters 110, 120, and 130 in the conveyance direction of the recording medium. An area of the first belt 30 heated by the heaters 110, 120, and 130 first comes into contact with the first roller 710. This is because the thermostat 510 is arranged at a position near the heaters 110, 120, and 130 so that runaway of the heaters 110, 120, and 130 can be detected as quickly as possible.

The first roller 710 is a metal roller with a metal surface. The metal surface improves thermal response and facilitates heat transfer from the first belt 30. Accordingly, runaway of the heaters 110, 120, and 130 can be detected as quickly as possible.

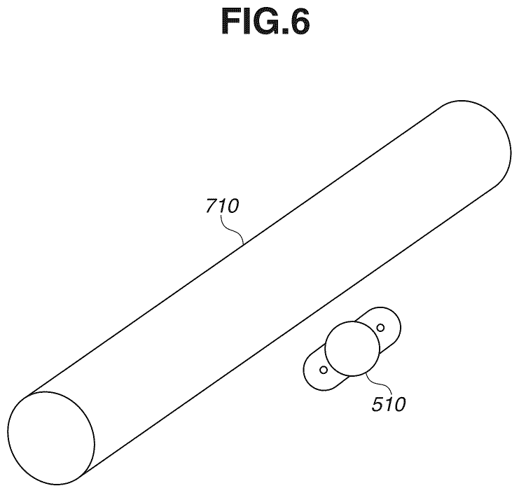

FIG. 6 illustrates a configuration of the thermostat 510 and the first roller 710. The thermostat 510 detects the temperature of the first roller 710 contactlessly. The thermostat 510 is installed at a certain distance from the first roller 710.

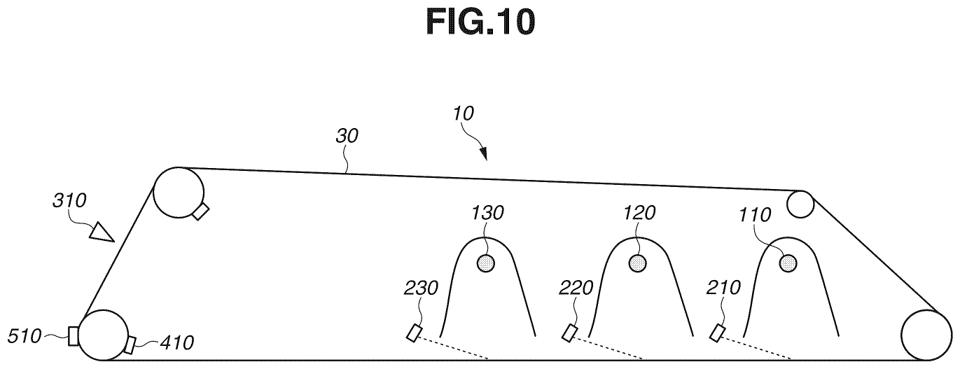

FIG. 10 illustrates the thermostat 510 arranged outside the first belt 30. The thermostat 510 is arranged outside the first belt 30.

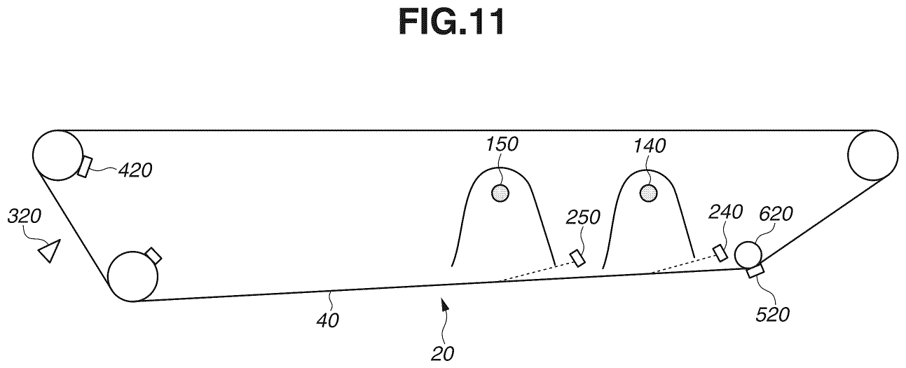

FIG. 11 illustrates the thermostat 520 arranged outside the second belt 40. The thermostat 520 is arranged outside the second belt 40.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-127217, filed Aug. 3, 2023, which is hereby incorporated by reference herein in its entirety.

What is claimed is:

1. An ink-jet recording apparatus comprising:
an ink image forming unit configured to form an ink image on a recording medium; and
a fixing apparatus that is arranged downstream of the ink image forming unit in a conveyance direction of the recording medium and is configured to fix the ink image on the recording medium while pinching and conveying the recording medium,
wherein the fixing apparatus includes:
a first belt configured to rotate and come into contact with the ink image formed by the ink image forming unit;
a second belt configured to form a nip portion by coming into contact with the first belt;
a first roller unit including a plurality of rollers that comes into contact with an inner circumferential surface of the first belt and on which the first belt is suspended;
a second roller unit including a plurality of rollers that comes into contact with an inner circumferential surface of the second belt and on which the second belt is suspended;
a first heater unit that is arranged on the inner circumferential surface of the first belt and is configured to heat the nip portion contactlessly; and
a second heater unit configured to heat the inner circumferential surface of the second belt contactlessly and to correspond to the second belt.

2. The ink-jet recording apparatus according to claim 1, wherein the fixing apparatus includes a pad member that is arranged on the inner circumferential surface of the second belt and forms the nip portion together with the first belt via the second belt.

3. The ink-jet recording apparatus according to claim 2, wherein the second heater unit heats the inner circumferential surface of the second belt other than the nip portion.

4. The ink-jet recording apparatus according to claim 3,
wherein the first heater unit includes a plurality of halogen heaters, and
wherein the second heater unit includes a plurality of halogen heaters.

5. The ink-jet recording apparatus according to claim 4, wherein the halogen heaters included in the first heater unit are arranged along the conveyance direction.

6. The ink-jet recording apparatus according to claim 5, wherein a number of halogen heaters included in the first heater unit is greater than a number of halogen heaters included in the second heater unit.

7. The ink-jet recording apparatus according to claim 6, wherein the first heater unit and the second heater unit include reflectors.

8. The ink-jet recording apparatus according to claim 7, wherein the reflectors included in the first heater unit and the second heater unit are open in a same direction.

9. The ink-jet recording apparatus according to claim 1,
wherein the first roller unit includes a first roller that is arranged downstream of the nip portion in the conveyance direction, and
wherein the ink-jet recording apparatus further includes a first temperature detection member configured to detect a temperature of the first roller.

10. The ink-jet recording apparatus according to claim 9, wherein the first temperature detection member is not in contact with the first roller.

11. The ink-jet recording apparatus according to claim 10, wherein the first roller is a metal roller.

12. The ink-jet recording apparatus according to claim 11,
wherein the first roller unit includes a drive roller connected to a drive source to be driven to rotate, and
wherein the drive roller has a rubber surface.

13. The ink-jet recording apparatus according to claim 1, further comprising a second temperature detection member configured to detect a temperature of an outer circumferential surface of the first belt,
wherein the second temperature detection member detects the temperature of the outer circumferential surface of the first belt other than the nip portion.
